(19) United States
(12) Patent Application Publication
(10) Pub. No.: US 2016/0117851 A1
(43) Pub. Date: Apr. 28, 2016

(54) METHOD AND APPARATUS FOR DISPLAYING STATICTICAL GRAPHS ON A TERMINAL DISPLAY

(71) Applicant: Alibaba Group Holding Limited, George Town (KY)

(72) Inventor: Ke ZHANG, Hangzhou (CN)

(21) Appl. No.: 14/918,278

(22) Filed: Oct. 20, 2015

(30) Foreign Application Priority Data
Oct. 22, 2014 (CN) 201410568406.X

(51) Int. Cl. G06T 11/20

(52) U.S. Cl. CPC G06T 11/206; G06T 11/203; G06T 2207/20072

(57) ABSTRACT

A method of displaying statistical graphs on a terminal display includes the steps of: obtaining a count of subgraphs to be displayed in a statistical graph, the count having a value of N; selecting N number of sample points from a line in a color coordinate space; obtaining N number of colors corresponding to the N number of sample points for displaying the statistical graph, wherein colors of neighboring subgraphs correspond to neighboring sample points of the line, the N number of colors form a one to one relationship with the N sample points respectively; and displaying the statistical graph. The number of statistical data types can be used to select a same number of different colors to obtain a statistical graph with color gradients formed by its subgraphs for displaying. It solves the problem of the present statistical systems, with only a fixed number of colors for rendering statistical graphs, when the amount of statistical data types are tremendous, running out colors. As a result, the displaying effect of statistical results is more clear and precise, with less amount of CPU computation and less amount of energy usage.

### CROSS REFERENCE TO RELATED APPLICATION

This application claims the benefits to Chinese Patent Application No. 201410568406.X, filed on Dec. 22, 2014, which is incorporated herein by reference in its entirety.

### TECHNICAL FIELD

The present invention relates generally to data information processing, and more particularly to displaying statistical graphs on a terminal display.

### BACKGROUND

Presently, in the field of statistical products offered by various web sites, only a fixed number of colors are utilized for rendering statistical graphs. However, usually due to the different data types encountered and unforeseeabilities, data sent from back ends do not have sufficient number of colors at a front page for displaying. When the number of data types exceeds the number of colors, a commonly practiced approach is to manually recycle the colors already in use for rendering. When the number of data types are tremendous, this approach wastes time and effort, leading to repeated color usage (i.e., a same color is used to represent different data types), which is not easy for users to discern.

### SUMMARY

An object of the present invention is to provide a method and apparatus for displaying statistical graphs on a terminal display. It solves the problem of the present statistical systems, with only a fixed number of colors for rendering statistical graphs, when a tremendous amount of data types are under statistical analysis, running out colors for displaying. As a result, the displaying effect of statistical results is more clear and precise.

In order to solve the above described technical problems, according to an exemplary embodiment in accordance with the present disclosure, a method of displaying statistical graphs on a terminal display includes the step of obtaining a count of subgraphs to be displayed in a statistical graph, the count of subgraphs having a value of N. The method further includes selecting N number of sample points from a line in a color coordinate space. The method also includes obtaining N number of colors corresponding to the N number of sample points respectively to render the statistical graph with, where colors of neighboring subgraphs correspond to neighboring sample points from the line, the N number of colors have a one to one relationship with the N number of subgraphs respectively. The method further includes displaying the statistical graph on the terminal display.

According to another exemplary embodiment in accordance with the present disclosure, an apparatus for displaying statistical graphs on a terminal includes a number acquisition module, a sample point selection module, a color acquisition module, and a rendering module. The number acquisition module is configured for displaying statistical graphs on a terminal display includes the step of obtaining a count of subgraphs to be displayed in a statistical graph, the count of subgraphs having a value of N. The sample point selection module is configured for selecting N number of sample points from a line in a color coordinate space. The color acquisition module is configured for obtaining N number of colors corresponding to the N number of sample points respectively to render the statistical graph. The colors of the neighboring subgraphs of the statistical graph correspond to the neighboring sample points from the line, with the N number of colors having a one to one relationship with the N number of subgraphs respectively. The rendering module is configured for displaying the statistical graph on the terminal display.

In comparison to the present technologies, the primary differences and effects provided by embodiments in accordance with the present disclosure are that, with a sample line in a color coordinate space, the number of statistical data types can be used to select a same number of different colors to obtain a statistical graph with color gradients formed by its subgraphs for displaying. It solves the problem of the present statistical systems, with only a fixed number of colors for rendering statistical graphs, when the amount of statistical data types are tremendous, thereby running out colors. As a result, the displaying effect of statistical results is more clear and precise, with less amount of CPU computation and less amount of energy usage.

Further, when sample points are selected from a straight line with the same or proportional spacing distances from each other, the spacing distances can be selected such that there is sufficient color difference between the colors represented by the two sample points. For example, when statistical results are rendered with a pie chart or the like, the subgraphs of the pie chart, i.e., the fan segments, have obvious color difference from each other and form a color gradient such that the statistical results are displayed clearly and precisely.

Furthermore, using a Bézier curve, i.e., an open model of curves with changing parameters, with the same spacing distance between sample points, color gradients having obvious color differences can be similarly obtained to display the subgraphs of a statistical graph.

Also, in theory, there are only about 443 types of colors that can be presented along a straight line; while with a curve, there are as many as 256*256*256=16,777,216 types of colors that can be represented. Therefore, the use of a curve provides for more choices to select sample points which present color types of obvious color differences.

The details of one or more embodiments of the disclosure are set forth in the accompanying drawings and the description below. Other features, objects, and advantages of the disclosure will be apparent from the description and drawings, and from the claims.

### DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a flow chart of an exemplary method of displaying statistical graphs in accordance with a first embodiment of the present disclosure;

FIG. 2 illustrates an exemplary two-dimensional color space used in accordance with the first embodiment of the present disclosure;

FIG. 3 is a pie chart rendered by selecting sample points by use of a two-dimensional color space in accordance with the first embodiment of the present disclosure;

FIG. 4 illustrates an example of selecting sample points by use of a Bézier curve in a two-dimensional color space in accordance with the first embodiment of the present disclosure;

FIG. 5 is a pie chart rendered by selecting sample points by use of the Bézier curve in the two-dimensional color space in accordance with the first embodiment of the present disclosure; and

FIG. 6. is a block diagram of an exemplary apparatus for displaying statistical graphs on a terminal display in accordance with a second embodiment of the present disclosure.

### DETAILED DESCRIPTION

In the following description, numerous specific details are set forth in order to provide a thorough understanding of the present disclosure. However, it will become obvious to those skilled in the art that the present disclosure may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments mutually exclusive of other embodiments. Used herein, the terms “upper”, “lower”, “top”, “bottom”, “middle”, “upwards”, and “downwards” are intended to provide relative positions for the purposes of description, and are not intended to designate an absolute frame of reference. Further, the order of blocks in process flowcharts or diagrams representing one or more embodiments of the disclosure do not inherently indicate any particular order nor imply any limitations in the disclosure.

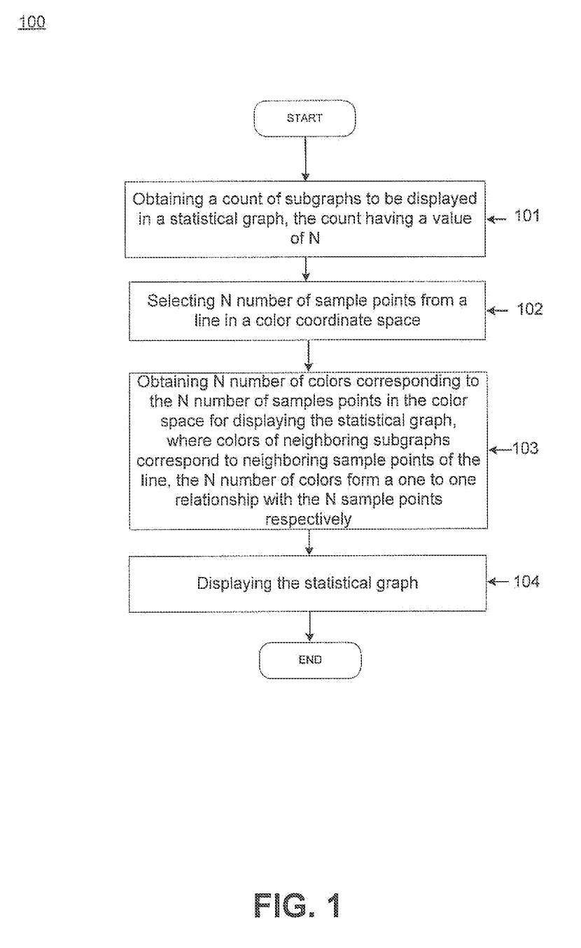

Embodiments of the present disclosure are discussed herein with reference to FIGS. 1-6. However, those skilled in the art will readily appreciate that the detailed description given herein with respect to these figures is for explanatory purposes as the disclosure extends beyond these limited embodiments.

In accordance with the present disclosure, a subgraph refers to a component of a statistical graph and represents one type of data out of all the statistical data. Each subgraph is displayed with a different color to present a different type of data.

Referring to FIG. 1, a flow chart of an exemplary method of displaying statistical graphs on a terminal display in accordance to an embodiment of the present disclosure is shown to include the following steps. The method 100 starts in step 101, where the count of the subgraphs of a statistical graph to be displayed on the terminal display is obtained. The count of the subgraphs has a value of N, where N is a natural number. Then in step 102, N number of sample points are selected from a line in a color coordinate space. Next, in step 103, N number of colors that correspond to the N number of sample points in the color coordinate space are obtained for displaying the statistical graph. Colors of neighboring subgraphs correspond to neighboring sample points from the line in the color coordinate space; and the N number of colors have a one to one relationship with the N number of subgraphs respectively. The method 100 concludes after step 104, where the statistical graph is displayed at the terminal display.

In accordance with embodiments of the present disclosure, the farther the distance between two neighboring sample points at the line in the color space is, the more difference in the two colors corresponding to the two neighboring subgraphs of the statistical graph, which is to be rendered eventually, and the more obvious color gradient of the displayed statistical graph. Further, the line in the color coordinate space can be either a straight line or a curve.

In a preferred embodiment of the present disclosure, the line in the color coordinate space is a straight line, and the above described step 102 includes the step of selecting N number of sample points from the straight line in the color coordinate space such that the spacing distances between neighboring sample points are the same or form a geometric sequence along a direction of the straight line.

Further, it can be understood that the selecting of N number of sample points can be implemented as first selecting two end points as sample points, then selecting N-2 number of sample points between the two end points such that the neighboring sample points have the same spacing distance. Alternatively, it can be implemented as first determining a spacing distance between neighboring sample points, next selecting two neighboring sample points at the center of the line, then selecting other sample points using the two center sample points as the center towards the ends of the line, with an interval of the determined spacing distance between sample points. Also, it can be implemented with any other methods known to one with ordinary skills of the art.

In some other alternative embodiments of the present disclosure, it can also be implemented such that, with the spacing distances between neighboring sample points being non-fixed or non-proportional, sample points with similar effects of color gradients can be selected. For example, N sample points can be selected such that spacing distances between the neighboring sample points form a geometric sequence, for example, the spacing distances between two neighboring sample points can be ordered as 2, 4, 8, 16, . . . . Alternatively, the spacing distances between the neighboring sample points can be ordered into an arithmetic sequence. Alternatively, the line segments between sample points can be divided in a circular manner, for example, the spacing distances between neighboring sample points can be ordered as 2, 4, 6, 2, 4, 6, . . . .

When selecting sample points from a straight line with the spacing distances being the same or proportional between neighboring sample points, an appropriate distance can be chosen such that there is sufficiently obvious color difference between two sample points. For example, when rendering a pie chart or the like statistical graph for displaying corresponding statistical results, via selecting sample points with appropriate spacing distance, the subgraphs of the pie chart, i.e., the fan segments can be rendered with obvious color difference as well as obvious color gradients, thus presenting the statistical results clearly and precisely. In another preferred embodiment of the present disclosure, the line in the color coordinate space is a Bézier curve, and the above described step 102 includes the step of selecting N number of sample points from the Bézier curve.

Further, it can be understood that the methods of sample point selection from a straight line with a same spacing distance can be applied to sample point selection from the curve. Similarly, sample point selection from a straight line with spacing distances forming a geometric sequence or other patterns can also be applied to sample point selection from the curve.

Similarly, selecting sample points from a Bézier curve, an open model of curves with changing parameters, with a fixed spacing distance, color gradients with obvious color differences can also be obtained for rendering subgraphs of a statistical graph. In theory, there are only about 443 types of colors that can be presented along a straight line; while with a curve, there are as many as 256*256*256=16,777,216 types of colors that can be represented. Therefore, the use of a curve provides for more choices for selecting sample points which present color types of obvious color difference.

It can be understood that, in accordance with embodiments of the present disclosure, other types of curves can also be used for selecting sample points.

Further, it can be understood that, in accordance with embodiments of the present disclosure, color coordinate spaces can be based on the HSB, HSL or HSV color models. For example, hue (H), saturation (S) and brightness (B/L/V), or any two of those can be used as coordinates. Alternatively, it can also be based on a RGB color model. For example, red (R), green (G) and blue (B) three color channels can be used as the coordinates of the color coordinate space. For another example, in a preferred embodiment of the present disclosure, the color coordinate space is a three dimensional space, where the three coordinates of the three dimensional color space represent hue, brightness and saturation respectively.

The HSB, HSL and HSV color models all represent points in an RGB color model in a cylindrical coordinate system. Those representation methods try to be more intuitive than the geometry of the RGB model in a Cartesian coordinate system. HSL stands for hue, saturation and lightness, which can also be termed HLS. HSV stands for hue, saturation and value, which can also be termed HSB, B standing for brightness. Hue (H) is a basic characteristic of a color, i.e., color name in general reference, for example, red, yellow, etc. Saturation (S) refers to the purity of a color—the higher the purity, the purer the color; the lower the purity, the grayer the color. Saturation values range from 0 to 100%; and Value (V) and Lightness (L) values range from 0 to 100%.

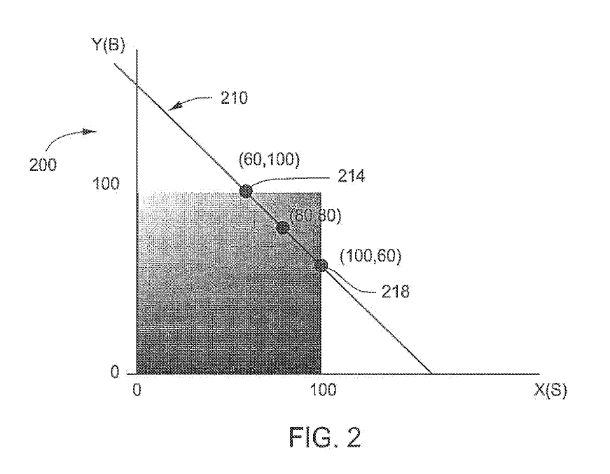

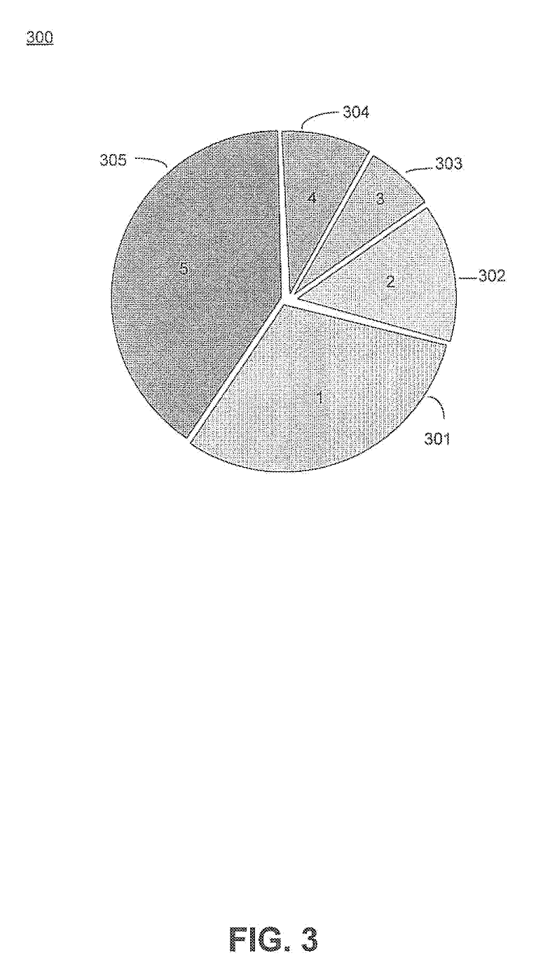

It can be understood that, in other alternative embodiments of the present disclosure, a color coordinate space can be two-dimensional. For example, as illustrated in FIG. 2, in an exemplary implementation, with the value of the hue element (H) of the HSB model being fixed, in a color picker, a color coordinate space 200 of a plane with two dimensions is formed with saturation value (S) assigned to the X axis and brightness value (B) assigned to the Y axis. Based on the number of subgraphs corresponding to the statistical data, two points, for example, point 214 of coordinates (60,100) and point 218 of coordinates (100, 60) in the two dimensional color coordinate space are selected. The line 210 between the two points 214 and 218 is divided into N-2 segments of the same length, as a result of which the coordinates for the N sample points for rendering the statistical graph are determined. When N equals 5, a pie chart 300 rendered accordingly is shown as in FIG. 3. The colors of subgraphs 1 to 5 (i.e., fan segments 301, 302, 303, 304 and 305) form a color gradient, with the colors darkening along the gradient.

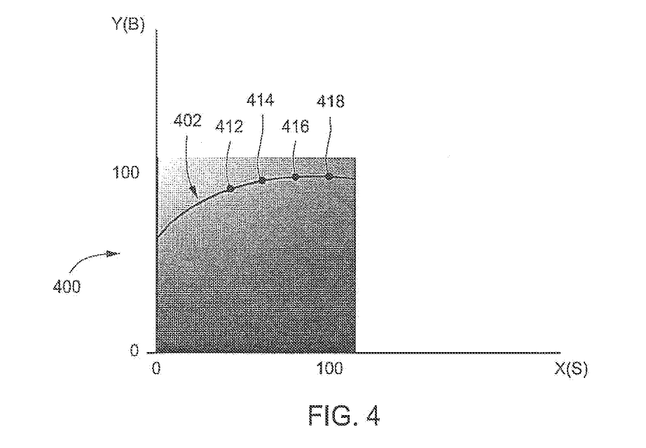

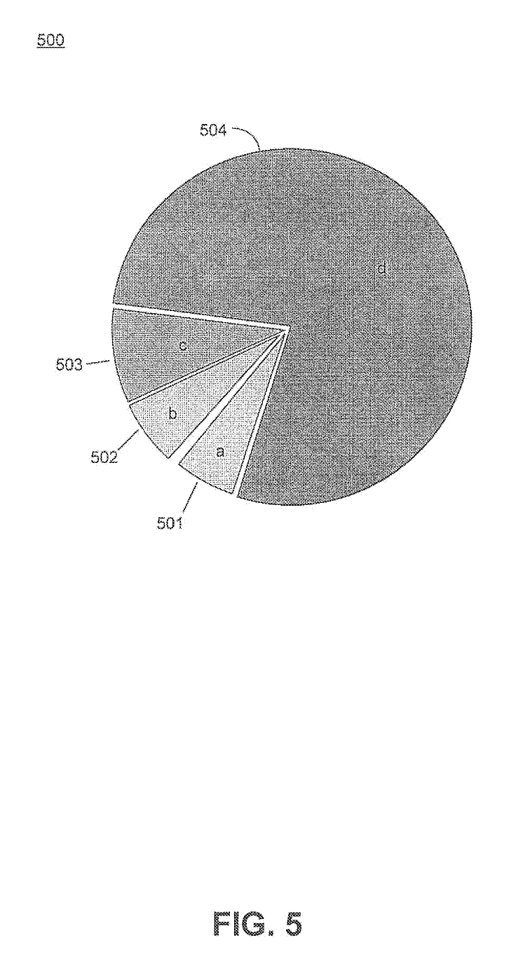

As shown in FIG. 4, in another exemplary implementation of the present disclosure, in the above described two dimensional plane 400 with saturation as X axis and brightness as Y axis, a Bézier curve 402 is utilized to select N number of sample points such that the space distances between the neighboring sample points are the same. FIG. 4 illustrates 4 sample points 412, 414, 416 and 418 on the Bézier curve 402 being selected for displaying a pie chart (as shown in FIG. 5).

As shown in FIG. 5, the colors of subgraphs a to b (i.e., fan segments 501, 502, 503 and 504) of the pie chart 500 form a color gradient, with the colors darkening along the gradient. Here, a pie chart is a circular statistical chart divided into several fan shaped segments for illustrating relative relationships between quantities, frequencies or percentages. The arc length of a fan segment of a pie chart (and consequently its central angle and area) is proportional to the quantity it represents. All the fan segments fitting together form a complete circle.

Further, depending on particular conditions, coordinates of sample points in a color coordinate space based on the HSB, HSL or HSV color models can be converted into corresponding coordinates in a RGB color model, then applied to the displaying of the statistical graph. Furthermore, it is understood that, in accordance with embodiments of the present disclosure, the sources of statistical data can be network data, data from offline databases, etc. Statistical graphs to be displayed can be pie charts, histogram charts, bar charts, area charts, line charts, scatter plot chart, curved surface charts, donut charts, and other commonly used statistical graphs. For example, in a preferred embodiment of the present disclosure, the statistical graph is a pie chart, stacked histogram chart or donut chart.

With a sample point line in a color coordinate space, the number of statistical data types can be used to select a same number of different colors to obtain a statistical graph with color gradients formed by its subgraphs for displaying. It solves the problem of the present statistical systems, with only a fixed number of colors for rendering statistical graphs, when the amount of statistical data types are tremendous, running out colors. As a result, the displaying effect of statistical results is more clear and precise, with less amount of CPU computation and less amount of energy usage.

Embodiments of the present disclosure can be implemented using software, hardware, firmware, and/or the combinations thereof. Regardless of being implemented using software, hardware, firmware or the combinations thereof, instruction code can be stored in any kind of computer readable media (for example, permanent or modifiable, volatile or non-volatile, solid or non-solid, fixed or changeable medium, etc.). Similarly, such medium can be implemented using, for example, programmable array logic (PAL), random access memory (RAM), programmable read only memory (PROM), read only memory (ROM), electrically erasable programmable ROM (EEPROM), magnetic storage, optical storage, digital versatile disc (DVD), or the like.

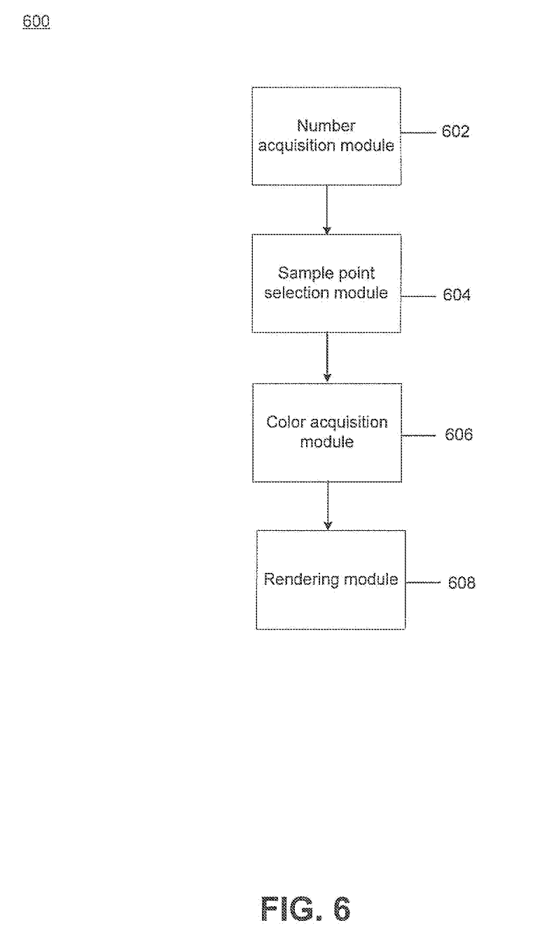

Referring now to FIG. 6, a block diagram of an exemplary apparatus for displaying statistical graphs on a terminal display, in accordance with a second embodiment of the present disclosure is shown. The apparatus 600 for displaying statistical graphs on a terminal display includes a number acquisition module 602, a sample point selection module 604, a color acquisition module 606, and a rendering module 608. The number acquisition module 602 is configured for obtaining the count of subgraphs to be displayed in a statistical graph, the count having a value of N. The sample point selection module 604 is configured for selecting N number of sample points from a line in a color coordinate space. The color acquisition module 606 is configured for obtaining N number of colors corresponding to the N number of sample points in the color space for displaying the statistical graph. Colors of neighboring subgraphs correspond to neighboring sample points of the line; and the N number of colors form a one to one relationship with the N sample points respectively. The rendering module 608 is configured for displaying the statistical graph.

Further, in a preferred embodiment of the present disclosure, the above described line in the color coordinate space is a straight line, and the sample point selection module includes a straight line selection sub-module configured for selecting N number of sample points from the straight line, where spacing distances between neighboring sample points being the same or forming a geometric sequence along a direction of the straight line.

Further, in another preferred embodiment of the present disclosure, the line in the color coordinate space is a Bézier curve, and the sample point selection module includes a curve selection sub-module configured for selecting N number sample points from the Bézier curve such that spacing distances between neighboring sample points are the same.

Furthermore, in yet another preferred embodiment of the present disclosure, the above described color coordinate space is a three dimensioned space, the three dimensions represent hue, brightness and saturation respectively.

Further, in still yet another preferred embodiment of the present disclosure, the above described the statistical graph is a pie chart, stacked bar chart, or ring-shaped chart.

The first embodiment corresponds to the instant embodiment of the present disclosure, the instant embodiment can be implemented in cooperation with the first embodiment. The technical details described in the first embodiment apply to the instant embodiment, and are not repeated herein for the purposes of reducing repetition. Accordingly, the technical details described in the instant embodiment apply to the first embodiment.

It is necessary to point out that, modules or blocks described by embodiments of the present disclosures are logical modules or logical blocks. Physically, a logical module or logical block can be a physical module or a physical block, a part of a physical module or a physical block, or the combinations of more than one physical modules or physical blocks. Physical implementation of those logical module or logical blocks is not of essence. The realized functionalities realized by the modules, blocks and the combinations thereof are key to solving the problems addressed by the present disclosure. Further, in order to disclose the novelties of the present disclosure, the above described embodiments do not disclose about those modules or blocks not too related to solving the problems addressed by the present disclosure, which does not mean that the above described embodiments cannot include other modules or blocks.

It is also necessary to point out that, in the claims and specification of the present disclosure, terms such as first and second only are for distinguishing an embodiment or an operation from another embodiment or operation. It does not require or imply that those embodiments or operations having any such real relationship or order. Further, as used herein, the terms “comprising,” “including,” or any other variation intended to cover a non-exclusive inclusion, such that a process, method, article, or apparatus that comprises a list of elements does not include only those elements but may include other elements not expressly listed or inherent to such process, method, article, or apparatus. Absent further limitation, elements recited by the phrase “comprising a” does not exclude a process, method, article, or apparatus that comprises such elements from including other same elements.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable medium used to actually carry out the distribution. The embodiments disclosed herein may also be implemented using software modules that perform certain tasks. These software modules may include script, batch, or other executable files that may be stored on a computer-readable storage media or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

Although the present disclosure and its advantages have been described in detail, it should be understood that various changes substitutions, and alterations can be made herein without departing from the spirit and scope of the disclosure as defined by the appended claims. Many modifications and variations are possible in view of the above teachings. The embodiments were chosen and described in order to best explain the principles of the disclosure and its practical applications, to thereby enable others skilled in the art to best utilize the disclosure and various embodiments with various modifications as may be suited to the particular use contemplated.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Embodiments according to the present disclosure are thus described. While the present disclosure has been described in particular embodiments, it should be appreciated that the disclosure should not be construed as limited by such embodiments, but rather construed according to the below claims.

What is claimed is:

1. A method of displaying statistical graphs on a terminal display, the method comprising the steps of:
obtaining a count of subgraphs to be displayed in a statistical graph, the count having a value of N;
selecting N number of sample points from a line in a color coordinate space;
obtaining N number of colors corresponding to the N number of sample points for displaying the statistical graph, wherein colors of neighboring subgraphs correspond to neighboring sample points of the line, the N number of colors form a one to one relationship with the N sample points respectively; and
displaying the statistical graph.

2. The method of claim 1, wherein the line is a straight line, and the step of selecting N number of sample points comprises the step of:
selecting N number of sample points from the straight line, wherein spacing distances between neighboring sample points being the same or forming a geometric sequence along a direction of the straight line.

3. The method of claim 1, wherein the line is a Bézier curve, and the step of selecting N number of sample points comprises the step of selecting N number sample points from the Bézier curve such that spacing distances between neighboring sample points are the same.

4. The method of claim 1, wherein the color coordinate space is a space with three dimensions, the three dimensions representing hue, brightness and saturation respectively.

5. The method of claim 1, wherein the statistical graph is a pie chart, stacked histogram chart, or ring-shaped chart.

6. An apparatus for displaying statistical graphs on a terminal display, the apparatus comprising:
a processor; and
a non-transitory computer-readable medium operably coupled to the processor, the non-transistory computer-readable medium having computer-readable instructions stored thereon to be executed when accessed by the processor, the instructions comprising:
a number acquisition module configured for obtaining a count of subgraphs to be displayed in a statistical graph, the count having a value of N;
a sample point selection module configured for selecting N number of sample points from a line in a color coordinate space;
a color acquisition module configured for obtaining N number of colors corresponding to the N number of sample points for displaying the statistical graph, wherein colors of neighboring subgraphs correspond to neighboring sample points of the line, the N number of colors form a one to one relationship with the N sample points respectively; and
a rendering module configured for displaying the statistical graph.

7. The apparatus of claim 6, wherein the line is a straight line, and the step of selecting N number of sample points comprises the step of selecting N number of sample points from the straight line, wherein spacing distances between neighboring sample points being the same or forming a geometric sequence along a direction of the straight line.

8. The apparatus of claim 6, wherein the line is a Bézier curve, and the step of selecting N number of sample points comprises the step of selecting N number sample points from the Bézier curvesuch that spacing distances between neighboring sample points are the same.

9. The apparatus of claim 6, wherein the color coordinate space is a space with three dimensions, the three dimensions representing hue, brightness and saturation respectively.

10. The apparatus of claim 6, wherein the statistical graph is a pie chart, stacked histogram chart, or ring-shaped chart.

11. A non-transitory computer readable storage medium having embedded therein program instructions, when executed by one or more processors of a device, causes the device to execute a process for displaying statistical graphs on a terminal display, the process comprising:
obtaining a count of subgraphs to be displayed in a statistical graph, the count having a value of N;
selecting N number of sample points from a line in a color coordinate space;
obtaining N number of colors corresponding to the N number of sample points for displaying the statistical graph, wherein colors of neighboring subgraphs correspond to neighboring sample points of the line, the N number of colors form a one to one relationship with the N sample points respectively; and
displaying the statistical graph.

12. The non-transitory computer readable storage medium of claim 11, wherein the line is a straight line, and the step of selecting N number of sample points comprises the step of selecting N number of sample points from the straight line, wherein spacing distances between neighboring sample points being the same or forming a geometric sequence along a direction of the straight line.

13. The non-transitory computer readable storage medium of claim 11, wherein the line is a Bézier curve, and the step of selecting N number of sample points comprises the step of selecting N number sample points from the Bézier curve such that spacing distances between neighboring sample points are the same.

14. The non-transitory computer readable storage medium of claim 11, wherein the color coordinate space is a space with three dimensions, the three dimensions representing hue, brightness and saturation respectively.

15. The non-transitory computer readable storage medium of claim 11, wherein the statistical graph is a pie chart, stacked histogram chart, or ring-shaped chart.
